(19) United States
(12) Patent Application Publication
(10) Pub. No.: US 2025/0053276 A1
(43) Pub. Date: Feb. 13, 2025

(54) QUESTIONNAIRE DISPLAY METHOD, INFORMATION PROCESSING DEVICE, AND RECORDING MEDIUM RECORDING PROGRAM

(71) Applicant: SEIKO EPSON CORPORATION, Tokyo (JP)

(72) Inventors: Takashi NATORI, SUWA-SHI (JP); Sayaka HIROTA, AZUMINO-SHI (JP)

(21) Appl. No.: 18/796,569

(22) Filed: Aug. 7, 2024

(30) Foreign Application Priority Data
Aug. 7, 2023 (JP) 2023-128359

(51) Int. Cl. G06F 3/0482

(52) U.S. Cl. CPC G06F 3/0482

(57) ABSTRACT

A questionnaire display method includes, in a smartphone, displaying a first screen for selecting a first function or another function of an application program based on operation from a user, and displaying a questionnaire concerning the first function when the first function is not selected within a predetermined period.

The present application is based on, and claims priority from JP Application Serial Number 2023-128359, filed Aug. 7, 2023, the disclosure of which is hereby incorporated by reference herein in its entirety.

### BACKGROUND

### 1. Technical Field

The present disclosure relates to a questionnaire display method, an information processing device, and a recording medium recording a program.

### 2. Related Art

For example, JP-A-2006-244050 describes that, when the number of times of starting an application or an operation time satisfies a predetermined condition, a questionnaire is sent to efficiently perform an accurate and effective questionnaire survey according to a survey purpose.

JP-A-2006-244050 is an example of the related art.

In the technique described in JP-A-2006-244050, when a user who is a target of a questionnaire does not use the application in a manner assumed in the application, a proper questionnaire result is sometimes not obtained.

### SUMMARY

An aspect of the present disclosure is a questionnaire display method including: in an information processing device, displaying a first screen for selecting a first function or another function of an application program based on operation from a user; and displaying a questionnaire concerning the first function when the first function is not selected within a predetermined period.

Another aspect of the present disclosure is an information processing device including at least one processor, wherein the at least one processor executes: displaying a first screen for selecting a first function or another function of an application program based on operation from a user; and displaying a questionnaire concerning the first function when the first function is not selected within a predetermined period.

Still another aspect of the present disclosure is a recording medium recording a program, the program causing a processor to execute: displaying a first screen for selecting a first function or another function of an application program based on operation from a user; and displaying a questionnaire concerning the first function when the first function is not selected within a predetermined period.

### BRIEF DESCRIPTION OF THE DRAWINGS

FIG. 1 is a diagram illustrating an example of a configuration of a display system according to an embodiment.

FIG. 2 is a diagram illustrating an example of a configuration of a projector.

FIG. 3 is a diagram illustrating an example of a configuration of a smartphone.

FIG. 4 is a diagram illustrating an example of a hierarchical structure of functions of an application program.

FIG. 5 is a table illustrating an example of a relation among a function, a degree of importance, and a predetermined number of times.

FIG. 6 is a screen diagram illustrating an example of a first screen.

FIG. 7 is a flowchart illustrating an example of processing of the smartphone.

FIG. 8 is a flowchart illustrating an example of count processing.

FIG. 9 is a flowchart illustrating another example of the count processing.

### DESCRIPTION OF EMBODIMENTS

An embodiment is explained below with reference to the drawings.

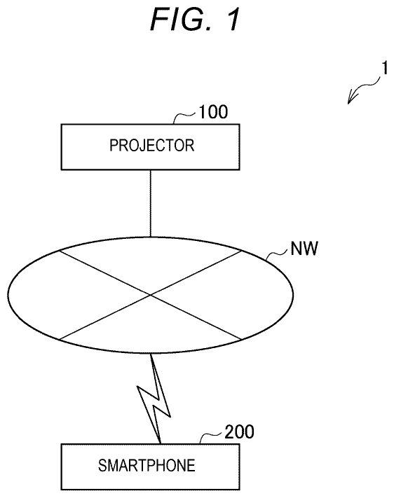

FIG. 1 is a diagram illustrating an example of a configuration of a display system 1 according to the present embodiment. The display system 1 includes a projector 100 and a smartphone 200. The smartphone 200 is configured to be capable of communicating with the projector 100 via a network NW.

In the present embodiment, the network NW is, for example, a LAN (Local Area Network) but is not limited to the LAN. The network NW may be, for example, a WAN (Wide Area Network). The network NW may be, for example, the Internet.

The projector 100 is disposed in a conference room, a classroom, or the like and projects image light PL onto, for example, a screen SC. The projector 100 projects the image light PL to display a projection image PM on the screen SC.

In the present embodiment, in the following explanation, the projector 100 displays the projection image PM on the screen SC. However, the projector 100 is not limited to this. The projector 100 may display the projection image PM on a wall surface such as a side wall.

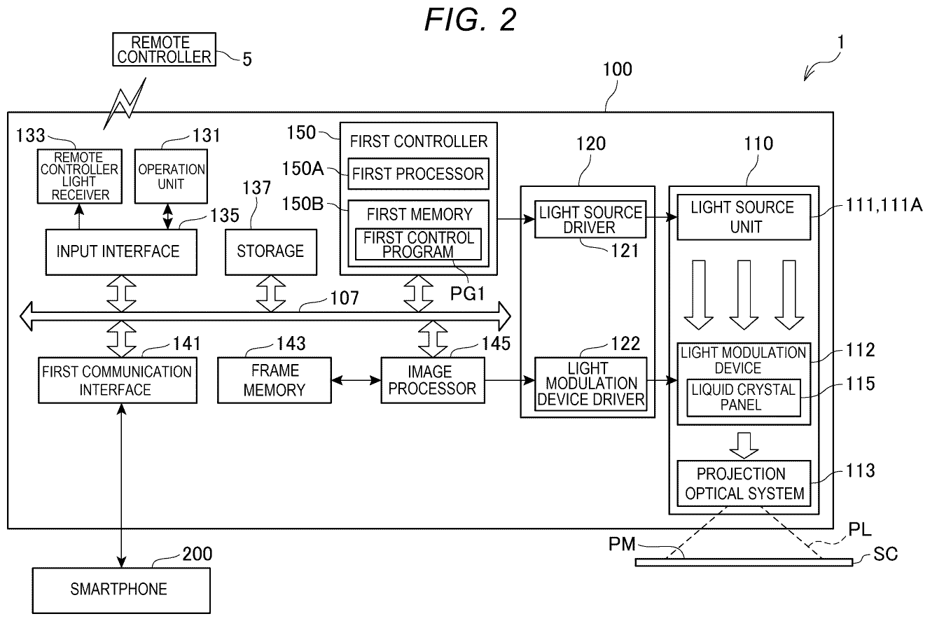

The projector 100 is further explained with reference to FIG. 2.

The smartphone 200 is wirelessly communicably connected to, by Wi-Fi (registered trademark) or the like, a not-illustrated base station communicably connected to the network NW.

The smartphone 200 is carried by a user. The smartphone 200 is configured to be capable of executing various functions FN for the projector 100 by executing an application program AP.

The smartphone 200 corresponds to an example of an “information processing device”.

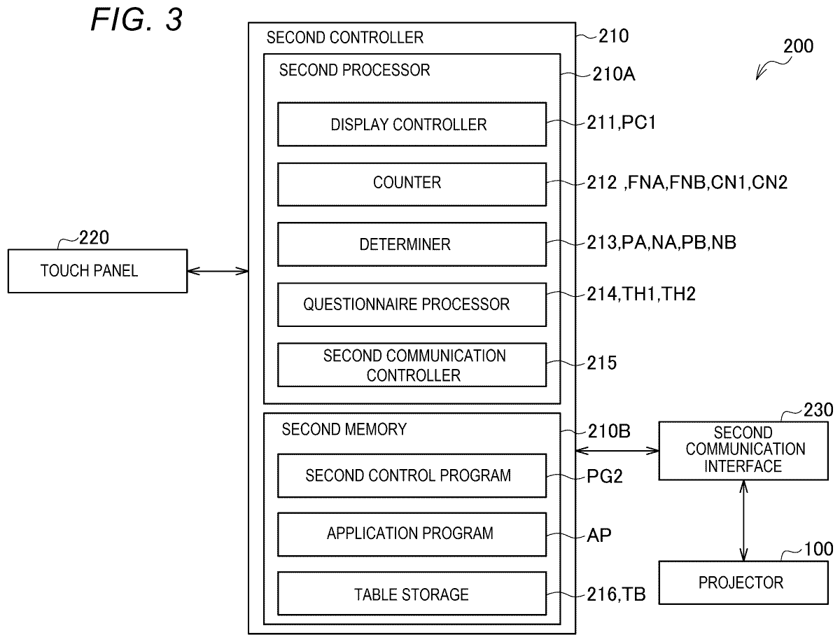

The smartphone 200 is further explained with reference to FIG. 3.

In the present embodiment, the “information processing device” is configured by the smartphone 200. However, the “information processing device” may be configured by a tablet terminal, a personal computer, or the like.

In the present embodiment, the smartphone 200 is wire-communicably connected to the projector 100 by an Ethernet (registered trademark) cable or the like configuring the network NW. However, the smartphone 200 may be wirelessly communicably connected by Wi-Fi (registered trademark) or the like.

Subsequently, a configuration of the projector 100 is explained with reference to FIG. 2. FIG. 2 is a diagram illustrating an example of a configuration of the projector 100 according to the present embodiment.

As illustrated in FIG. 2, the projector 100 includes a projection unit 110 and a driver 120 that drives the projection unit 110. The projection unit 110 forms an optical image and projects the image light PL onto the screen SC. In the present embodiment, the projection unit 110 projects the image light PL corresponding to the projection image PM onto the screen SC.

The projection unit 110 includes a light source unit 111, a light modulation device 112, and a projection optical system 113. The driver 120 includes a light source driver 121 and a light modulation device driver 122.

The light source unit 111 includes a light source 111A. The light source 111A is, for example, a solid-state light source such as an LED (Light Emitting Diode) or a laser light source.

In the present embodiment, a case is explained in which the light source 111A of the light source unit 111 is a solid-state light source. However, the light source 111A is not limited to this. The light source 111A of the light source unit 111 may be a lamp light source such as a halogen lamp, a xenon lamp, or an ultra-high pressure mercury lamp.

The light source unit 111 may include a reflector and an auxiliary reflector that guide light emitted by the light source 111A to the light modulation device 112. The light source unit 111 may further include, for example, a lens group for improving an optical characteristic of projected light, a polarizing plate, or a dimming element for reducing, on a path leading to the light modulation device 112, a light amount of light emitted by a light source.

The light source driver 121 is coupled to an internal bus 107, turns on and off the light source 111A of the light source unit 111 according to an instruction of a first controller 150 coupled to the internal bus 107, and controls output of the light source 111A.

The light modulation device 112 includes, for example, three liquid crystal panels 115 corresponding to three primary colors of R, G, and B. R represents red, G represents green, and B represents blue. That is, the light modulation device 112 includes the liquid crystal panel 115 corresponding to R color light, the liquid crystal panel 115 corresponding to G color light, and the liquid crystal panel 115 corresponding to B color light.

Light emitted by the light source unit 111 is separated into color lights of three colors of RGB, which are respectively made incident on the liquid crystal panels 115 corresponding thereto. Each of the three liquid crystal panels 115 is a transmissive liquid crystal panel and modulates transmitted light to generate first image light. First image lights modulated by passing through the liquid crystal panels 115 are combined by a combination optical system such as a cross dichroic prism and emitted to the projection optical system 113.

In the present embodiment, a case is explained in which the light modulation device 112 includes the transmissive liquid crystal panels 115 as light modulation elements. However, the light modulation device 112 is not limited to this. The light modulation elements may be reflective liquid crystal panels or may be digital micromirror devices.

The light modulation device 112 is driven by the light modulation device driver 122. The light modulation device driver 122 is coupled to an image processor 145.

Image data corresponding to the primary colors of R, G, and B are input to the light modulation device driver 122 from the image processor 145. The light modulation device driver 122 converts the input image data into data signals suitable for an operation of the liquid crystal panel 115. The light modulation device driver 122 applies, based on the data signals obtained by the conversion, a voltage to pixels of the liquid crystal panels 115 and draws images on the liquid crystal panels 115.

The projection optical system 113 includes a projection lens, a mirror, and the like that cause the image light PL made incident thereon to form an image on the screen SC. The projection optical system 113 includes a zoom mechanism that enlarges or reduces an image projected on the screen SC, a focus adjustment mechanism that adjusts a focus, a lens shift mechanism that adjusts a projection direction of the image light PL, and the like.

The projector 100 further includes an operation unit 131, a remote controller light receiver 133, an input interface 135, a storage 137, a first communication interface 141, a frame memory 143, the image processor 145, and the first controller 150. The input interface 135, the storage 137, the first communication interface 141, the image processor 145, and the first controller 150 are coupled to one another via the internal bus 107 to be capable of performing data communication.

The operation unit 131 includes various buttons and switches provided at a housing surface of the projector 100, generates operation signals corresponding to operation of the buttons and switches, and outputs the operation signals to the input interface 135. The input interface 135 includes a circuit that outputs an operation signal input from the operation unit 131 to the first controller 150.

The remote controller light receiver 133 receives an infrared signal transmitted from a remote controller 5 and decodes the received infrared signal to generate an operation signal. The remote controller light receiver 133 outputs the generated operation signal to the input interface 135. The input interface 135 includes a circuit that outputs the operation signal input from the remote controller light receiver 133 to the first controller 150.

The storage 137 is, for example, a magnetic recording device such as a HDD (Hard Disk Drive) or a storage device including a semiconductor storage element such as a flash memory or a SSD (Solid State Drive). The storage 137 stores a program executed by the first controller 150, data processed by the first controller 150, image data, and the like.

The first communication interface 141 is a communication interface that executes communication with the smartphone 200 according to the Ethernet (registered trademark) standard. The first communication interface 141 includes a connector for coupling an Ethernet cable and an interface circuit for processing a signal transmitted through the connector. The first communication interface 141 is an interface board including a connector and an interface circuit and is coupled to a main board on which a first processor 150A of the first controller 150 and the like are mounted. Alternatively, the connector and the interface circuit configuring the first communication interface 141 are mounted on the main board of the first controller 150. The first communication interface 141 receives image data and the like from the smartphone 200.

The first controller 150 includes a first memory 150B and the first processor 150A.

The first memory 150B is a storage device that stores programs to be executed by the first processor 150A and data in a nonvolatile manner. The first memory 150B includes a magnetic storage device, a semiconductor storage element such as a flash ROM (Read Only Memory), or a nonvolatile storage device of another type. The first memory 150B may also include a RAM (Random Access Memory) configuring a work area of the first processor 150A. The first memory 150B stores data processed by the first controller 150, a first control program PG1 to be executed by the first processor 150A, and the like.

The first controller 150 controls operations of the units of the projector 100 according to an instruction from the smartphone 200.

The first processor 150A may be configured by a single processor, or a plurality of processors may function as the first processor 150A. The first processor 150A executes the first control program PG1 to control the units of the projector 100. For example, the first processor 150A outputs an instruction to execute image processing corresponding to operation received by the operation unit 131 and the remote controller 5 and parameters used for the image processing to the image processor 145. The parameters include, for example, a geometric correction parameter for correcting geometric distortion of an image projected on the screen SC. The first processor 150A controls the light source driver 121 to turn on and off the light source unit 111 and adjusts output, that is, a light amount of the light source unit 111.

The first processor 150A may be configured by an SoC (System on Chip) integrated with part or all of the first memory 150B and other circuits. The first processor 150A may be configured by a combination of a CPU (Central Processing Unit) that executes a program and a DSP (Digital Signal Processor) that executes predetermined arithmetic processing. All of the functions of the first processor 150A may be implemented in hardware or may be configured using a programmable device.

The image processor 145 and the frame memory 143 can be configured by, for example, an integrated circuit. The integrated circuit includes an LSI (Large-Scale Integration), an ASIC (Application Specific Integrated Circuit), and a PLD (Programmable Logic Device). The PLD includes, for example, an FPGA (Field-Programmable Gate Array). A part of a configuration of the integrated circuit may include an analog circuit. A processor and the integrated circuit may be combined. The combination of the processor and the integrated circuit is called a microcontroller (MCU), an SoC (System-on-a-chip), a system LSI, a chip set, or the like.

The image processor 145 loads, in the frame memory 143, image data input from the first communication interface 141. The frame memory 143 includes a plurality of banks. The banks each have a storage capacity capable of writing image data for one frame. The frame memory 143 is configured by, for example, an SDRAM (Synchronous Dynamic Random Access Memory).

The image processor 145 performs, on the image data loaded in the frame memory 143, image processing such as resolution conversion processing or resize processing, distortion aberration correction, shape correction processing, digital zoom processing, and adjustment of a tint and luminance of an image.

The image processor 145 generates a vertical synchronization signal obtained by converting an input frame frequency of a vertical synchronization signal into a drawing frequency. The generated vertical synchronization signal is referred to as an output synchronization signal. The image processor 145 outputs the generated output synchronization signal to the light modulation device driver 122.

Subsequently, a configuration of the smartphone 200 is explained with reference to FIG. 3.

FIG. 3 is a diagram illustrating an example of a configuration of the smartphone 200 according to the present embodiment. As illustrated in FIG. 3, the smartphone 200 includes a second controller 210, a touch panel 220, and a second communication interface 230. The second controller 210 includes a second processor 210A and a second memory 210B. The second controller 210 controls operations of the units of the smartphone 200.

The touch panel 220 and the second communication interface 230 are coupled to the second controller 210.

The touch panel 220 includes an LCD (Liquid Crystal Display) and a touch sensor formed integrally with the LCD. The LCD of the touch panel 220 displays various images according to instructions from the second controller 210. The touch sensor of the touch panel 220 receives operation from the user. The touch panel 220 generates an operation signal corresponding to the received operation and outputs the generated operation signal to the second controller 210.

The second communication interface 230 includes a connector and an interface circuit and is coupled to the second controller 210. In the present embodiment, the second communication interface 230 is an interface for communicating with the projector 100 according to, for example, the Wi-Fi (registered trademark) standard.

The second processor 210A is configured by a CPU, a DSP, a microcomputer, or the like. The second processor 210A may be configured by a plurality of processors or may be configured by a single processor.

The second processor 210A may be hardware programmed to implement functions of units explained below. That is, the second processor 210A may have a configuration in which a second control program PG2 is loaded as a hardware circuit. In this case, for example, the second processor 210A is configured by an ASIC, an FPGA, or the like.

In the following explanation, the second processor 210A executes the second control program PG2 to implement various functions of the second controller 210.

The second processor 210A corresponds to an example of a “processor”.

The second memory 210B has a storage area for storing programs to be executed by the second processor 210A and data to be processed by the second processor 210A. The second memory 210B stores the second control program PG2 to be executed by the second processor 210A and the application program AP for executing various functions concerning the projector 100.

The second memory 210B includes a nonvolatile storage area that stores the programs and the data in a nonvolatile manner. The second memory 210B may include, for example, a ROM, an HDD, or an SSD as the nonvolatile storage area. The second memory 210B may also include a volatile storage area and configure a work area for temporarily storing the programs to be executed by the second processor 210A and the data to be processed. The second memory 210B may include, for example, a RAM as the volatile storage area.

As illustrated in FIG. 3, the second controller 210 includes a display controller 211, a counter 212, a determiner 213, a questionnaire processor 214, a second communication controller 215, and a table storage 216. For example, the second processor 210A executes the second control program PG2, whereby these units are implemented by cooperation of software and hardware.

The second control program PG2 corresponds to an example of a “program”.

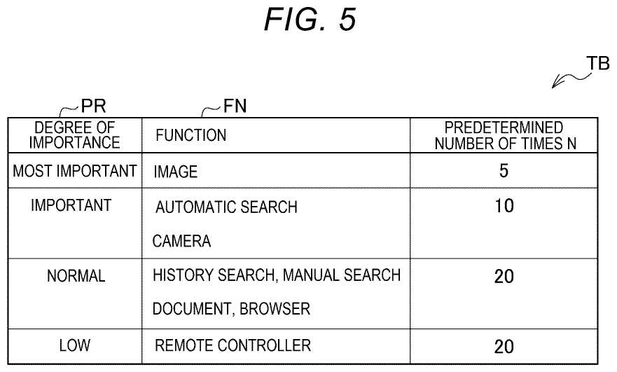

The table storage 216 stores, in advance, an importance degree table TB illustrated in FIG. 5. The importance degree table TB is explained with reference to FIG. 5.

The display controller 211 displays a first screen PC1 for selecting a function FN of the application program AP based on operation from the user. The display controller 211 causes, for example, according to an instruction from the application program AP, the LCD of the touch panel 220 to display the first screen PC1.

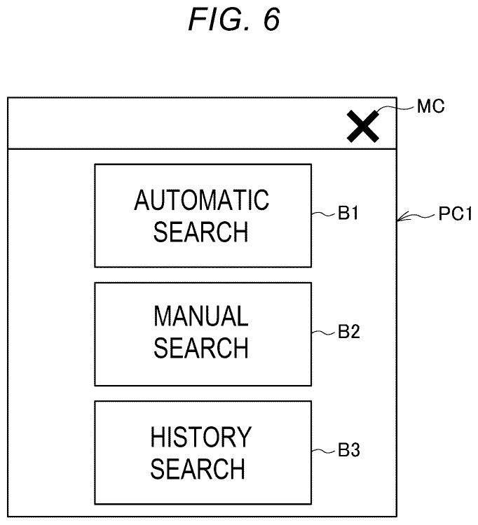

The first screen PC1 is further explained with reference to FIG. 6.

The counter 212 determines, based on operation of the user on the first screen PC1, whether a first function FNA has been selected. Further, the counter 212 determines, based on operation of the user on the first screen PC1, whether a second function FNB has been selected. Each of the first function FNA and the second function FNB corresponds to an example of the function FN of the application program AP.

The second function FNB corresponds to an example of “another function”.

The counter 212 executes “count processing”. The “count processing” is processing of updating a value of a first counter CN1 and a value of a second counter CN2 according to a result of determination about whether the first function FNA has been selected and whether the second function FNB has been selected.

When determining that the second function FNB has been selected, the counter 212 adds one to the value of the first counter CN1. When determining that the first function FNA has been selected, the counter 212 adds one to the value of the second counter CN2.

When determining that the first function FNA has been selected, the counter 212 may reset the value of the first counter CN1 to zero. When determining that the second function FNB has been selected, the counter 212 may reset the value of the second counter CN2 to zero.

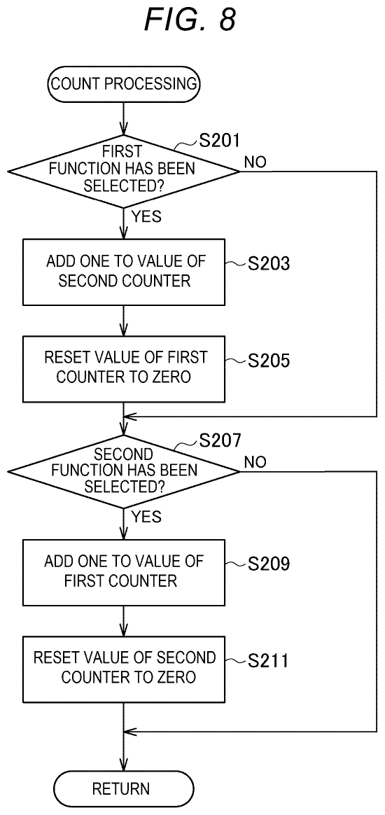

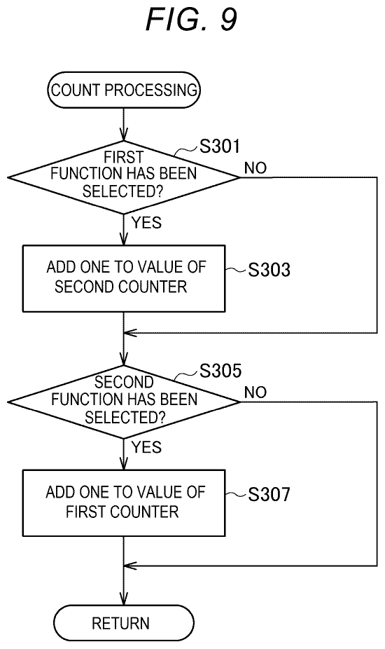

The “count processing” is further explained with reference to FIGS. 8 and 9.

The determiner 213 determines whether the first function FNA has been selected within a predetermined period PA. The determiner 213 determines whether the second function FNB has been selected within a predetermined period PB.

The predetermined period PA is a period until the second function FNB is selected a first number of times NA without the first function FNA being selected. The first number of times NA is set in association with the first function FNA according to the importance degree table TB. The first number of times NA is set to a smaller number of times as the degree of importance of the first function FNA is higher.

The predetermined period PB is a period until the first function FNA is selected a second number of times NB without the second function FNB being selected. The second number of times NB is set in association with the second function FNB according to the importance degree table TB. The second number of times NB is set to a smaller number of times as the degree of importance of the second function FNB is higher.

Here, the “degree of importance” indicates, for example, a degree to which a creator of the application program AP wants the user to use the application program AP. In other words, the stronger the creator of the application program AP wants the user to use the application program AP, the higher the “degree of importance” is.

When the determiner 213 determines that the first function FNA is not selected within the predetermined period PA, the questionnaire processor 214 displays a questionnaire concerning the first function FNA. When the first function FNA is not selected within the predetermined period PA, the questionnaire processor 214 causes the LCD of the touch panel 220 to display, for example, the questionnaire concerning the first function FNA.

When the determiner 213 determines that the second function FNB is not selected within the predetermined period PB, the questionnaire processor 214 displays a questionnaire concerning the second function FNB. When the second function FNB is not selected within the predetermined period PB, the questionnaire processor 214 causes the LCD of the touch panel 220 to display, for example, the questionnaire concerning the second function FNB.

When the end of the execution of the application program AP is instructed by the user, the questionnaire processor 214 causes the LCD of the touch panel 220 to display a questionnaire.

When the end of the execution of the application program AP is instructed by the user, for example, when the value of the first counter CN1 is equal to or larger than a predetermined value corresponding to the first number of times NA, the questionnaire processor 214 displays the questionnaire concerning the first function FNA. That is, when the value of the first counter CN1 is equal to or larger than a first threshold TH1 corresponding to the first number of times NA, the questionnaire processor 214 causes the LCD of the touch panel 220 to display the questionnaire concerning the first function FNA.

When the end of the execution of the application program AP is instructed by the user, for example, when the value of the second counter CN2 is equal to or larger than a second threshold TH2 corresponding to the second number of times NB, the questionnaire processor 214 displays the questionnaire concerning the second function FNB. That is, when the value of the second counter CN2 is equal to or larger than the second threshold TH2 corresponding to the second number of times NB, the questionnaire processor 214 causes the LCD of the touch panel 220 to display the questionnaire concerning the second function FNB.

The second communication controller 215 communicates with the projector 100 via the second communication interface 230. The second communication controller 215 transmits image data corresponding to the projection image PM to, for example, the projector 100. The second communication controller 215 transmits a command CM indicating an instruction to, for example, the projector 100.

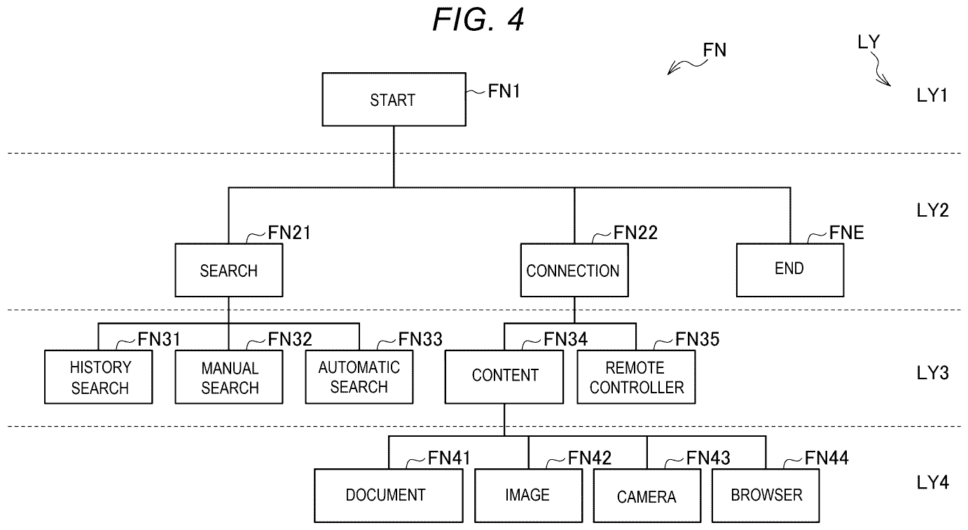

Subsequently, a hierarchical structure of the function FN of the application program AP is explained with reference to FIG. 4. FIG. 4 is a diagram illustrating an example of the hierarchical structure of the function FN of the application program AP.

As illustrated in FIG. 4, the function FN of the application program AP includes four layers LY indicated by a first layer LY1, a second layer LY2, a third layer LY3, and a fourth layer LY4. The first layer LY1 includes a start function FN1.

The second layer LY2 includes a search function FN21, a connection function FN22, and an end function FNE. By executing the end function FNE, the execution of the application program AP is ended.

The third layer LY3 includes a history search function FN31, a manual search function FN32, and an automatic search function FN33 as functions lower in order than the search function FN21. The third layer LY3 includes a content function FN34 and a remote controller function FN35 as functions lower in order than the connection function FN22.

The fourth layer LY4 includes a document function FN41, an image function FN42, a camera function FN43, and a browser function FN44 as functions lower in order than the content function FN34.

The first function FNA and the second function FNB explained with reference to FIG. 3 belong to the same layer. The function FN higher in order than the first function FNA matches the function FN higher in order than the second function FNB.

The first function FNA is, for example, the automatic search function FN33 and the second function FNB is, for example, the history search function FN31 or the manual search function FN32. In this case, the function FN higher in order than the first function FNA and the second function FNB is the search function FN21.

The first function FNA is, for example, the image function FN42 and the second function FNB is, for example, the document function FN41, the camera function FN43, or the browser function FN44. In this case, the function FN higher in order than the first function FNA and the second function FNB is the content function FN34.

Subsequently, a relation among the function FN, the degree of importance PR, and the predetermined number of times N is explained with reference to FIG. 5. FIG. 5 is a table illustrating an example of the relation among the function FN, the degree of importance PR, and the predetermined number of times N.

The predetermined number of times N corresponds to the first number of times NA and the second number of times NB. That is, when the first function FNA is set as the function FN, the predetermined number of times N corresponding to the function FN corresponds to the first number of times NA. When the second function FNB is set as the function FN, the predetermined number of times N corresponding to the function FN corresponds to the second number of times NB.

The table illustrated in FIG. 5 corresponds to an example of the importance degree table TB.

In FIG. 5, the degree of importance PR is described in a left field, the function FN is described in a center field, and the predetermined number of times N is described in a right field.

The degree of importance PR is classified into, for example, “most important”, “important”, “normal”, and “low” in descending order of the degree of importance PR.

As the function FN, the degree of importance PR of which is “most important”, the image function FN42 is set. The predetermined number of times N corresponding to the image function FN42 is five. That is, when the image function FN42 is set as the first function FNA, the predetermined number of times N is set to five.

As the function FN, the degree of importance PR of which is “important”, the automatic search function FN33 and the camera function FN43 are set. The predetermined number of times N corresponding to the automatic search function FN33 and the camera function FN43 is ten. That is, when the automatic search function FN33 or the camera function FN43 is set as the first function FNA, the predetermined number of times N is set to ten.

As the function FN, the degree of importance PR of which is “normal”, the history search function FN31, the manual search function FN32, the document function FN41, and the browser function FN44 are set. The predetermined number of times N corresponding to the history search function FN31, the manual search function FN32, the document function FN41, and the browser function FN44 is twenty. That is, when the history search function FN31, the manual search function FN32, the document function FN41, or the browser function FN44 is set as the second function FNB, the second number of times NB is set to twenty.

As the function FN, the degree of importance PR of which is “low”, the remote controller function FN35 is set. The predetermined number of times N corresponding to the remote controller function FN35 is twenty. That is, when the remote controller function FN35 is set as the second function FNB, the second number of times NB is set to twenty.

For example, the creator of the application program AP sets which function FN is set as the first function FNA and the second function FNB. It is preferable that the function FN to be set can be changed as the first function FNA and the second function FNB, for example, when the application program AP is upgraded.

Subsequently, the first screen PC1 is explained with reference to FIG. 6. FIG. 6 is a screen diagram illustrating an example of the first screen PC1.

When the search function FN21 has been selected, the display controller 211 causes the LCD of the touch panel 220 to display the first screen PC1 illustrated in FIG. 6. As illustrated in FIG. 6, an automatic search button B1, a manual search button B2, a history search button B3, and a cancel mark MC are displayed on the first screen PC1. The first function FNA is set to, for example, the automatic search function FN33. The second function FNB is set to, for example, the history search function FN31 or the manual search function FN32.

The automatic search button B1 is touched by the user when the user instructs execution of the automatic search function FN33. In other words, when the user touches the automatic search button B1, the application program AP executes the automatic search function FN33. When the user touches the automatic search button B1, the counter 212 determines that the first function FNA has been selected.

The manual search button B2 is touched by the user when the user instructs execution of the manual search function FN32. In other words, when the user touches the manual search button B2, the application program AP executes the manual search function FN32. When the user touches the manual search button B2, the counter 212 determines that the second function FNB has been selected.

The history search button B3 is touched by the user when the user instructs execution of the history search function FN31. In other words, when the user touches the history search button B3, the application program AP executes the history search function FN31. When the user touches the history search button B3, the counter 212 determines that the second function FNB has been selected.

The cancel mark MC is touched by the user when the user ends the display of the first screen PC1 illustrated in FIG. 6. When the user touches the cancel mark MC, the display controller 211 executes the following processing according to an instruction from the application program AP. That is, the display controller 211 ends the display of the first screen PC1 illustrated in FIG. 6. Then, the display controller 211 displays, as the first screen PC1, a screen for selecting any one of the search function FN21, the connection function FN22, and the end function FNE of the second layer LY2 higher in order than the history search function FN31, the manual search function FN32, and the automatic search function FN33.

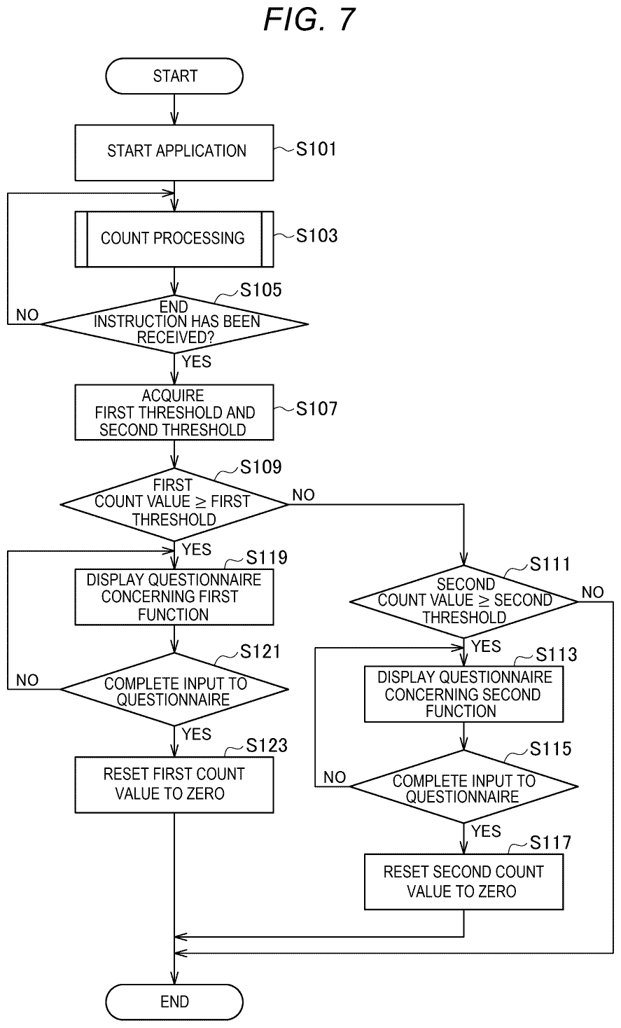

Subsequently, processing of the second controller 210 of the smartphone 200 is explained with reference to FIG. 7. FIG. 7 is a flowchart illustrating an example of processing of the second controller 210 of the smartphone 200.

In the flowcharts illustrated in FIGS. 7 to 9, the first function FNA is set to, for example, the automatic search function FN33 and the second function FNB is set to, for example, the history search function FN31 or the manual search function FN32.

As illustrated in FIG. 7, first, in step S101, the second controller 210 starts the application program AP based on operation from the user. For example, when the user touches an icon corresponding to the application program AP, the second controller 210 starts the application program AP.

Subsequently, in step S103, the counter 212 executes “count processing”. The “count processing” is processing of updating a value of the first counter CN1 and a value of the second counter CN2 according to a result of determination about whether the first function FNA has been selected and whether the second function FNB has been selected. The “count processing” is further explained with reference to FIGS. 8 and 9.

Subsequently, in step S105, the questionnaire processor 214 determines whether the end of the execution of the application program AP has been instructed by the user.

When the questionnaire processor 214 determines that the end of the execution of the application program AP has not been instructed by the user (step S105; NO), the processing returns to step S103. When the questionnaire processor 214 determines that the end of the execution of the application program AP has been instructed by the user (step S105; YES), the processing proceeds to step S107.

In step S107, the determiner 213 acquires the first threshold TH1 and the second threshold TH2 from the importance degree table TB stored in the table storage 216. The first threshold TH1 indicates a value of the first number of times NA. The first threshold TH1 is, for example, “10”. The second threshold TH2 indicates a value of the second number of times NB. The second threshold TH2 is, for example, “20”.

Subsequently, in step S109, the determiner 213 determines whether a first count value CM1 is equal to or larger than the first threshold TH1. The first count value CM1 indicates the value of the first counter CN1.

When the determiner 213 determines that the first count value CM1 is equal to or larger than the first threshold TH1 (step S109; YES), the processing proceeds to step S119. When the determiner 213 determines that the first count value CM1 is not equal to or larger than the first threshold TH1 (step S109; NO), the processing proceeds to step S111.

In step S111, the determiner 213 determines whether a second count value CM2 is equal to or larger than the second threshold TH2. The second count value CM2 indicates the value of the second counter CN2.

When the determiner 213 determines that the second count value CM2 is not equal to or larger than the second threshold TH2 (step S111; NO), the processing ends. When the determiner 213 determines that the second count value CM2 is equal to or larger than the second threshold TH2 (step S111; YES), the processing proceeds to step S113.

In step S113, the questionnaire processor 214 causes the LCD of the touch panel 220 to display a questionnaire concerning the second function FNB.

Subsequently, in step S115, the second controller 210 determines whether input to the questionnaire concerning the second function FNB by the user has been completed.

When the second controller 210 determines that the input to the questionnaire concerning the second function FNB by the user has not been completed (step S115; NO), the processing returns to step S113. When the second controller 210 determines that the input to the questionnaire concerning the second function FNB by the user has been completed (step S115; YES), the processing proceeds to step S117.

In step S117, the counter 212 resets the second count value CM2 to zero. Thereafter, the processing ends.

In the case of YES in step S109, in step S119, the questionnaire processor 214 causes the LCD of the touch panel 220 to display a questionnaire concerning the first function FNA.

Subsequently, in step S121, the second controller 210 determines whether input to the questionnaire concerning the first function FNA by the user has been completed.

When the second controller 210 determines that the input to the questionnaire concerning the first function FNA by the user has not been completed (step S121; NO), the processing returns to step S119. When the second controller 210 determines that the input to the questionnaire concerning the first function FNA by the user has been completed (step S121; YES), the processing proceeds to step S123.

In step S123, the counter 212 resets the first count value CM1 to zero. Thereafter, the processing ends.

Subsequently, an example of the count processing is explained with reference to FIG. 8. FIG. 8 is a flowchart illustrating the example of the count processing. The count processing illustrated in FIG. 8 is executed in step S103 of the flowchart illustrated in FIG. 7.

In FIG. 8, the first screen PC1 illustrated in FIG. 6 is displayed on the LCD of the touch panel 220 by the display controller 211.

As illustrated in FIG. 8, in step S201, the counter 212 determines, based on operation of the user on the first screen PC1, whether the first function FNA has been selected.

When the counter 212 determines that the first function FNA has not been selected (step S201; NO), the processing proceeds to step S207. When the counter 212 determines that the first function FNA has been selected (step S201; YES), the processing proceeds to step S203.

In step S203, the counter 212 adds one to the value of the second counter CN2.

Subsequently, in step S205, the counter 212 resets the value of the first counter CN1 to zero.

Next, in step S207, the counter 212 determines, based on operation of the user on the first screen PC1, whether the second function FNB has been selected.

When the counter 212 determines that the second function FNB has not been selected (step S207; NO), the processing returns to step S105 of the flowchart illustrated in FIG. 7. When the counter 212 determines that the second function FNB has been selected (step S207; YES), the processing proceeds to step S209.

In step S209, the counter 212 adds one to the value of the first counter CN1.

Subsequently, in step S211, the counter 212 resets the value of the second counter CN2 to zero. Thereafter, the processing returns to step S105 of the flowchart illustrated in FIG. 7.

Subsequently, another example of the count processing is explained with reference to FIG. 9. FIG. 9 is a flowchart illustrating the other example of the count processing. The count processing illustrated in FIG. 9 is executed in step S103 of the flowchart illustrated in FIG. 7.

In FIG. 9, the first screen PC1 illustrated in FIG. 6 is displayed on the LCD of the touch panel 220 by the display controller 211.

When determining that the first function FNA has been selected, in the count processing illustrated in FIG. 8, the counter 212 resets the value of the first counter CN1 to zero. However, the count processing illustrated in FIG. 9 is different in that the counter 212 does not reset the value of the first counter CN1 to zero.

When determining that the second function FNB has been selected, in the count processing illustrated in FIG. 8, the counter 212 resets the value of the second counter CN2 to zero. However, the count processing illustrated in FIG. 9 is different in that the counter 212 does not reset the value of the second counter CN2 to zero.

As illustrated in FIG. 9, in step S301, the counter 212 determines, based on operation of the user on the first screen PC1, whether the first function FNA has been selected.

When the counter 212 determines that the first function FNA has not been selected (step S301; NO), the processing proceeds to step S305. When the counter 212 determines that the first function FNA has been selected (step S301; YES), the processing proceeds to step S303.

In step S303, the counter 212 adds one to the value of the second counter CN2.

Subsequently, in step S305, the counter 212 determines, based on operation of the user on the first screen PC1, whether the second function FNB has been selected.

When the counter 212 determines that the second function FNB has not been selected (step S305; NO), the processing returns to step S105 of the flowchart illustrated in FIG. 7. When the counter 212 determines that the second function FNB has been selected (step S305; YES), the processing proceeds to step S307.

In step S307, the counter 212 adds one to the value of the first counter CN1. Thereafter, the processing returns to step S105 of the flowchart illustrated in FIG. 7.

### Present Embodiment and Action Effects

As explained above with reference to FIGS. 1 to 9, the questionnaire display method according to the present embodiment includes, in the smartphone 200, displaying the first screen PC1 for selecting the first function FNA or another function FN of the application program AP based on operation from the user and displaying a questionnaire concerning the first function FNA when the first function FNA is not selected within the predetermined period PA.

That is, when the first function FNA is not selected within the predetermined period PA, the questionnaire concerning the first function FNA is displayed.

Accordingly, by setting the predetermined period PA to a proper period, it is possible to display the questionnaire concerning the first function FNA at proper timing. Therefore, concerning the first function FNA, it is possible to obtain a proper questionnaire result.

In the questionnaire display method explained above, the predetermined period PA is a period until the other function FN is selected the first number of times NA without the first function FNA being selected.

Accordingly, by setting the first number of times NA to a proper number of times, it is possible to set the predetermined period PA to a proper period. Therefore, it is possible to display the questionnaire concerning the first function FNA at proper timing.

The questionnaire display method includes, adding one to the value of the first counter CN1 when the other function FN has been selected, setting the value of the first counter CN1 to zero when the first function FNA has been selected, and displaying a questionnaire concerning the first function FNA when the value of the first counter CN1 is equal to or larger than a first threshold corresponding to the first number of times NA.

Accordingly, it is possible to properly count the first number of times NA with a simple configuration. Therefore, by setting the first number of times NA to a proper number of times, it is possible to display the questionnaire concerning the first function FNA at proper timing with a simple configuration.

In addition, in the questionnaire display method, the other function FN includes the second function FNB, the predetermined period PB corresponding to the second function FNB is a period until the first function FNA is selected the second number of times NB without the second function FNB being selected, and the questionnaire display method includes adding one to the value of the second counter CN2 when the first function FNA has been selected, setting the value of the second counter CN2 to zero when the second function FNB has been selected, and displaying the questionnaire concerning the second function FNB when the value of the second counter CN2 is equal to or larger than the second threshold TH2 corresponding to the second number of times NB.

Accordingly, it is possible to properly count the second number of times NB with a simple configuration. Therefore, by setting the second number of times NB to a proper number of times, it is possible to display the questionnaire concerning the second function FNB at proper timing with a simple configuration.

In the questionnaire display method, the other function FN includes the second function FNB, and the questionnaire display method includes setting the value of the first counter CN1 and the value of the second counter CN2 to zero at the start time of the predetermined period PA, adding one to the value of the first counter CN1 when the first function FNA has been selected, adding one to the value of the second counter CN2 when the second function FNB has been selected, displaying the questionnaire concerning the first function FNA when the value of the first counter CN1 is equal to or larger than the first threshold TH1 corresponding to the first number of times NA, and displaying the questionnaire concerning the second function FNB when the value of the second counter CN2 is equal to or larger than the second threshold TH2 corresponding to the second number of times NB.

Accordingly, it is possible to properly count the first number of times NA and the second number of times NB with a simple configuration. Therefore, by setting each of the first number of times NA and the second number of times NB to a proper number of times, it is possible to display each of the questionnaire concerning the first function FNA and the questionnaire concerning the second function FNB at proper timing with a simple configuration.

In the questionnaire display method, the functions of the application program AP are hierarchized into the plurality of layers LY, and the first function FNA and the other functions FN belong to the same layer LY.

Accordingly, since the first function FNA and the other functions FN belong to the same layer LY, it is possible to selectively display the first function FNA and the other function FN on the first screen PC1. Therefore, by setting the predetermined period PA to a proper period, it is possible to display the questionnaire concerning the first function FNA at proper timing.

In the questionnaire display method, the displaying the questionnaire concerning the first function FNA is executed when the end of the execution of the application program AP is instructed by the user.

Accordingly, when the end of the execution of the application program AP is instructed by the user, it is possible to display the questionnaire concerning the first function FNA. Therefore, it is possible to suppress deterioration in convenience of the user involved in displaying the questionnaire.

In the questionnaire display method, the degree of importance PR is set for each of the functions FN of the application program AP, and the predetermined period PA is determined according to the degree of importance PR of the first function FNA.

Accordingly, since the predetermined period PA is determined according to the degree of importance PR of the first function FNA, it is possible to properly set the predetermined period PA. Therefore, by setting the predetermined period PA to a proper period, it is possible to display the questionnaire concerning the first function FNA at proper timing.

The smartphone 200 according to this embodiment includes the second processor 210A, and the second processor 210A executes displaying the first screen PC1 for selecting the first function FNA or the other function FN of the application program AP based on operation from the user and displaying the questionnaire concerning the first function FNA when the first function FNA is not selected within the predetermined period PA.

Therefore, the smartphone 200 according to the present embodiment can achieve the same effects as the effects of the questionnaire display method according to the present embodiment.

The second control program PG2 according to the present embodiment causes the second processor 210A to execute displaying the first screen PC1 for selecting the first function FNA or the other function FN of the application program AP based on operation from the user and displaying the questionnaire concerning the first function FNA when the first function FNA is not selected within the predetermined period PA.

Therefore, the second control program PG2 according to the present embodiment can achieve the same effects as the effects of the questionnaire display method according to the present embodiment.

### Other Embodiments

The present embodiment explained above is a preferred embodiment. However, the present disclosure is not limited to the embodiment explained above, and various modifications are possible without departing from the gist of the present disclosure.

In the present embodiment, as explained above, the smartphone 200 is configured by a personal computer. However, the smartphone 200 is not limited to this. The smartphone 200 may be configured by, for example, a tablet terminal or a smartphone. The smartphone 200 may be, for example, a server device.

In the present embodiment, as explained above, the application program AP executes the various functions FN concerning the projector 100. However, the application program AP is not limited to this. The application program AP may have a plurality of functions FN.

For example, the application program AP may be a document creation program or a spreadsheet program.

The application program AP may execute the various functions FN concerning electronic equipment other than the projector 100. The electronic equipment may be, for example, a printer.

In the present embodiment, as explained above, the predetermined period PA is the period until the other function FN is selected the first number of times NA without the first function FNA being selected. However, the predetermine period PA is not limited to this. For example, the predetermined period PA may be set in advance according to the degree of importance PR of the first function FNA. For example, the predetermined period PA may be a period corresponding to a time or the number of days in which the first function FNA is not selected. For example, the predetermined period PA is preferably set to a shorter period as the degree of importance PR of the first function FNA is higher.

In the present embodiment, as explained above, the other function FN is the second function FNB. However, the other function FN is not limited to this. For example, the other function FN may include a plurality of functions FN. When the other function FN includes the plurality of functions FN, the number of times each of the plurality of functions FN is selected may be counted.

In the present embodiment, as explained above, the first counter CN1 and the second counter CN2 are implemented by the second control program PG2. However, the first counter CN1 and the second counter CN2 are not limited to this. At least one of the first counter CN1 and the second counter CN2 may be implemented by a circuit.

The functional units illustrated in FIG. 3 indicate functional components. Specific implementation forms of the functional units are not particularly limited. That is, hardware individually corresponding to the functional units does not always need to be implemented. It is also possible to adopt a configuration in which one processor executes programs to implement functions of a plurality of functional units. In the embodiment explained above, a part of functions implemented by software may be implemented by hardware or a part of functions implemented by hardware may be implemented by software. Besides, specific detailed configurations of the units of the smartphone 200 can also be optionally changed without departing from the gist.

The processing units of the flowcharts illustrated in FIGS. 7 to 9 are divided according to the main processing contents in order to facilitate understanding of the processing of the second controller 210 of the smartphone 200. The processing units can also be divided into a larger number of processing units according to processing contents without being limited by a way and a name of division of the processing unit illustrated in the flowcharts of FIGS. 7 to 9 and can also be divided such that one processing unit includes a larger number of kinds of processing. Processing order of the flowcharts is not also limited to the illustrated example.

The questionnaire display method can be implemented by causing the second processor 210A provided in the smartphone 200 to execute the second control program PG2 corresponding to the questionnaire display method. The second control program PG2 can also be recorded in a recording medium in which the second control program PG2 is computer-readably recorded.

A magnetic or optical recording medium or a semiconductor memory device can be used as the recording medium. Specific examples of the recording medium include a portable or stationary recording medium such as a flexible disc, an HDD, a CD-ROM (Compact Disk Read Only Memory), a DVD, a Blu-ray (registered trademark) Disc, a magneto-optical disc, a flash memory, and a card type recording medium. In addition, the recording medium may be a nonvolatile storage device such as a RAM, a ROM, or an HDD, which is an internal storage device provided in the smartphone 200.

The questionnaire display method can also be realized by storing the second control program PG2 in a server device or the like and downloading the second control program PG2 from the server device to the smartphone 200.

### APPENDIXES

A summary of the present disclosure is appended below.

Appendix 1 A questionnaire display method comprising: in an information processing device, displaying a first screen for selecting a first function or another function of an application program based on operation from a user; and, when the first function is not selected within a predetermined period, displaying a questionnaire concerning the first function.

Consequently, when the first function is not selected within the predetermined period, the questionnaire concerning the first function is displayed.

Accordingly, by setting the predetermined period to a proper period, it is possible to display the questionnaire concerning the first function at proper timing. Therefore, it is possible to obtain a proper questionnaire result concerning the first function.

Appendix 2 The questionnaire display method according to the appendix 1, wherein the predetermined period is a period until the other function is selected a first number of times without the first function being selected.

Consequently, by setting the first number of times to a proper number of times, it is possible to set the predetermined period to a proper period. Therefore, it is possible to display the questionnaire concerning the first function at proper timing.

Appendix 3 The questionnaire display method according to the appendix 2, further comprising: adding one to a value of a first counter when the other function was selected; setting the value of the first counter to zero when the first function was selected; and displaying the questionnaire concerning the first function when the value of the first counter is equal to or larger than a first threshold corresponding to the first number of times.

Consequently, it is possible to properly count the first number of times with a simple configuration. Therefore, by setting the first number of times to a proper number of times, it is possible to display the questionnaire concerning the first function at proper timing with a simple configuration.

Appendix 4 The questionnaire display method according to the appendix 3, wherein the other function includes a second function, a predetermined period corresponding to the second function is a period until the first function is selected a second number of times without the second function being selected, and the questionnaire display method further comprises: adding one to a value of a second counter when the first function was selected; setting the value of the second counter to zero when the second function was selected; and displaying a questionnaire concerning the second function when the value of the second counter is equal to or larger than a second threshold corresponding to the second number of times.

Consequently, it is possible to properly count the second number of times with a simple configuration. Therefore, by setting the second number of times to a proper number of times, it is possible to display the questionnaire concerning the second function at proper timing with a simple configuration.

Appendix 5 The questionnaire display method according to any one of the appendixes 1 to 3, wherein the other function includes a second function, and the questionnaire display method further comprises: setting a value of a first counter and a value of a second counter to zero at a start time of the predetermined period; adding one to the value of the first counter when the first function was selected; adding one to the value of the second counter when the second function was selected; displaying the questionnaire concerning the first function when the value of the first counter is equal to or larger than a first threshold corresponding to a first number of times; and displaying a questionnaire concerning the second function when the value of the second counter is equal to or larger than a second threshold corresponding to a second number of times.

Consequently, it is possible to properly count the first number of times and the second number of times with a simple configuration. Therefore, by setting each of the first number of times and the second number of times to a proper number of times, it is possible to display each of the questionnaire concerning the first function and the questionnaire concerning the second function at proper timing with a simple configuration.

Appendix 6 The questionnaire display method according to any one of the appendixes 1 to 5, wherein functions of the application program are hierarchized into a plurality of layers, and the first function and the other function belong to a same layer.

Consequently, since the first function and the other function belong to the same layer, it is possible to selectively display the first function and the other function on the first screen. Therefore, by setting the predetermined period to a proper period, it is possible to display the questionnaire concerning the first function at proper timing.

Appendix 7 The questionnaire display method according to any one of the appendixes 1 to 6, wherein the displaying the questionnaire is executed when an end of execution of the application program is instructed by the user.

Consequently, when the end of the execution of the application program is instructed by the user, it is possible to display the questionnaire concerning the first function. Therefore, it is possible to suppress deterioration in convenience of the user involved in displaying the questionnaire.

Appendix 8 The questionnaire display method according to any one of the appendixes 1 to 7, wherein a degree of importance is set for each of functions of the application program, and the predetermined period is determined according to the degree of importance of the first function.

Consequently, since the predetermined period is determined according to the degree of importance of the first function, it is possible to properly set the predetermined period. Therefore, by setting the predetermined period to a proper period, it is possible to display the questionnaire concerning the first function at proper timing.

Appendix 9 An information processing device comprising at least one processor, the at least one processor executing: displaying a first screen for selecting a first function or another function of an application program based on operation from a user; and displaying a questionnaire concerning the first function when the first function is not selected within a predetermined period.

Consequently, the information processing device according to the appendix 9 achieves the same effects as the effects of the questionnaire display method according to the appendix 1.

Appendix 10 A recording medium recording a program, the program causing a processor to execute: displaying a first screen for selecting a first function or another function of an application program based on operation from a user; and displaying a questionnaire concerning the first function when the first function is not selected within a predetermined period.

Consequently, the recording medium recording the program according to the appendix 10 achieves the same effects as the effects of the questionnaire display method according to the appendix 1.

What is claimed is:

1. A questionnaire display method comprising:
in an information processing device, displaying a first screen for selecting a first function or another function of an application program based on operation from a user; and
when the first function is not selected within a predetermined period, displaying a questionnaire concerning the first function.

2. The questionnaire display method according to claim 1, wherein the predetermined period is a period until the other function is selected a first number of times without the first function being selected.

3. The questionnaire display method according to claim 2, further comprising:
adding one to a value of a first counter when the other function was selected;
setting the value of the first counter to zero when the first function was selected; and
displaying the questionnaire concerning the first function when the value of the first counter is equal to or larger than a first threshold corresponding to the first number of times.

4. The questionnaire display method according to claim 3, wherein
the other function includes a second function,
a predetermined period corresponding to the second function is a period until the first function is selected a second number of times without the second function being selected, and
the questionnaire display method further comprises:
adding one to a value of a second counter when the first function was selected;
setting the value of the second counter to zero when the second function was selected; and
displaying a questionnaire concerning the second function when the value of the second counter is equal to or larger than a second threshold corresponding to the second number of times.

5. The questionnaire display method according to claim 1, wherein
the other function includes a second function, and
the questionnaire display method further comprises:
setting a value of a first counter and a value of a second counter to zero at a start time of the predetermined period;
adding one to the value of the first counter when the first function was selected;
adding one to the value of the second counter when the second function was selected;
displaying the questionnaire concerning the first function when the value of the first counter is equal to or larger than a first threshold corresponding to a first number of times; and
displaying a questionnaire concerning the second function when the value of the second counter is equal to or larger than a second threshold corresponding to a second number of times.

6. The questionnaire display method according to claim 1, wherein
functions of the application program are hierarchized into a plurality of layers, and
the first function and the other function belong to a same layer.

7. The questionnaire display method according to claim 1, wherein the displaying the questionnaire is executed when an end of execution of the application program is instructed by the user.

8. The questionnaire display method according to claim 1, wherein
a degree of importance is set for each of functions of the application program, and
the predetermined period is determined according to the degree of importance of the first function.

9. An information processing device comprising at least one processor, the at least one processor executing:
displaying a first screen for selecting a first function or another function of an application program based on operation from a user; and
displaying a questionnaire concerning the first function when the first function is not selected within a predetermined period.

10. A recording medium recording a program, the program causing a processor to execute:
displaying a first screen for selecting a first function or another function of an application program based on operation from a user; and
displaying a questionnaire concerning the first function when the first function is not selected within a predetermined period.
